(19) United States
(12) Patent Application Publication
(10) Pub. No.: US 2025/0347579 A1
(43) Pub. Date: Nov. 13, 2025

(54) METHOD OF IN SITU LEAK MONITORING IN FLUID CIRCUITS

(71) Applicant: Applied Materials, Inc., Santa Clara, CA (US)

(72) Inventors: Hung X HOANG, Santa Clara, CA (US); Ricardo MARTINEZ, Manteca, CA (US); James F. GROCE, Santa Clara, CA (US); Stephan HENRICHS, Santa Clara, CA (US)

(21) Appl. No.: 18/662,748

(22) Filed: May 13, 2024

(51) Int. Cl. G01M 3/26; B24B 57/02

(52) U.S. Cl. CPC G01M 3/26; B24B 57/02

(57) ABSTRACT

The present disclosure describes a method of detecting failures in a semiconductor processing system. The method includes monitoring a pressure in a common conduit, stopping a first flow of a first fluid from a first conduit into the common conduit, monitoring the common conduit pressure for a first delay period after stopping the first flow, stopping a second flow of a second fluid from a second conduit into the common conduit, monitoring the common conduit pressure for a second delay period after stopping the second flow, closing a port of the common conduit, downstream of the first conduit and the second conduit, and monitoring the pressure in the common conduit after closing the port of the common conduit for a third delay period, and creating an error signal if the pressure in the common conduit does not reach a steady state within the first, second, or third delay period.

### BACKGROUND

### Field

Embodiments of the present invention generally relate to a method of signaling when a leak occurs in a semiconductor manufacturing system. In particular, methods and apparatus for minimizing contaminants during processing of semiconductor wafers are provided.

### Description of the Related Art

Substrate processing units perform cleaning operations prior to being packaged. The removal of contaminants during processing and packaging is always a focus in the semiconductor manufacturing industry. Contaminant removal is dependent on where the substrate is within the manufacturing process. Contamination of a system from leaks can increase costs and reduce efficiency. Efforts to maximize the efficiency of semi-conductor manufacturing systems to thereby reduce cost are always a consideration. Thus, there is a need in the art for more efficient apparatus and methods for minimizing contamination

### SUMMARY

The present disclosure describes a method of detecting failures in a semiconductor processing system according to one or more embodiments. The method includes monitoring a pressure in a common conduit, stopping a first flow of a first fluid from a first conduit into the common conduit, monitoring the common conduit pressure for a first delay period after stopping the first flow, stopping a second flow of a second fluid from a second conduit into the common conduit, monitoring the common conduit pressure for a second delay period after stopping the second flow, closing a port of the common conduit, downstream of the first conduit and the second conduit, and monitoring the pressure in the common conduit after closing the port of the common conduit for a third delay period, and creating an error signal if the pressure in the common conduit does not reach a steady state within the first, second, or third delay period.

In one or more embodiments, a processing circuit for use in semiconductor processing is provided. The processing circuit includes a process chamber configured for semiconductor manufacturing, a common conduit, a first conduit, a second conduit, and a controller. The common conduit includes a pressure sensor and a port coupled to the process chamber by a port valve. The first conduit is coupled to the common conduit by a first valve upstream of the port valve. The second conduit coupled to the common conduit by a second valve upstream of the port valve. The controller includes memory, the memory includes instructions that, when executed by one or more processors, cause a plurality of operations to be conducted. The plurality of operations include closing the first valve to stop a first flow of a first fluid from the first conduit into the common conduit, closing the second valve to stop a second flow of a second fluid from the second conduit into the common conduit, after a first delay period subsequent to closing the second valve, closing the port valve of the common conduit, after a second delay period subsequent to closing the port valve, monitoring, for a third period, a pressure in the common conduit using the pressure sensor, and taking one or more actions if the pressure in the common conduit is outside of a first pressure threshold.

In one or more embodiments, a processing circuit for use in semiconductor processing is provided. The processing circuit includes one or more supply circuits, a first supply manifold, a second supply manifold, a master flow meter, and a controller. Each supply circuit of the one or more supply circuits includes a common conduit with a pressure sensor and a port valve coupled to one or more outlets of the one or more supply circuits. Each outlet of the one or more outlets includes a mass flow monitor. Each supply circuit of the one or more supply circuits also includes a first conduit coupled to the common conduit by a first valve upstream of the port valve and a second conduit coupled to the common conduit by a second valve upstream of the port valve. The first supply manifold is coupled to the first conduit of each of the one or more supply circuits. The second supply manifold is coupled to the second conduit of each of the one or more supply circuits. The master flow meter is disposed upstream of the second supply manifold. The controller includes memory with instructions that, when executed by one or more processors, cause a plurality of operations to be conducted. The plurality of operations includes monitoring a pressure in the common conduit of each of the one or more supply circuits using the pressure sensor of the respective common conduit, monitoring a first mass flow rate through each outlet of the one or more outlets of the one or more supply circuits using the mass flow monitor of the respective outlet, determining a combined mass flow rate through the one or more supply circuits based on the first mass flow rate through each outlet of the one or more outlets of the one or more supply circuits, monitoring a second mass flow rate through the master flow meter, comparing a pressure in the common conduit of each of the one or more supply circuits with a pressure threshold, comparing the second mass flow rate with the combined mass flow rate, and taking one or more actions if the pressure in the common conduit in at least one of the one or more supply circuits is outside of the pressure threshold during a period when the first valve, the second valve, and the port valve corresponding to the respective common conduit are closed, or the combined mass flow rate is outside of a flow threshold of the second mass flow rate.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the disclosure and are therefore not to be considered limiting of its scope, as the disclosure may admit to other equally effective embodiments.

FIG. 1 is a schematic illustration of a fluid circuit of a semiconductor processing system according to some embodiments.

FIG. 2 is a schematic illustration of a semiconductor processing system according to some embodiments.

FIG. 3 is a schematic block diagram of a method for generating an error signal, according to one or more embodiments.

FIG. 4 is a schematic block diagram of a method for generating an error signal, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Substrates, also known as wafers, are moved within different units for various stages during the semiconductor manufacturing process. Cleaning and packaging units and modules are particularly focused on minimizing contaminants between different operations in a unit and between the modules. An apparatus used to transport different fluids to different modules within a unit is an area that has been improved by this disclosure. The following discussion includes new features that can be incorporated into a fluid supply system that reduces the potential to transmit contaminants between different modules and operations of the semiconductor manufacturing process.

The following disclosure includes a method to minimize cross contamination between different parts of a semiconductor manufacturing system. The novel method includes monitoring pressure, flow rate, or both within fluid conduits of a semiconductor manufacturing system to detect component failures or leaks.

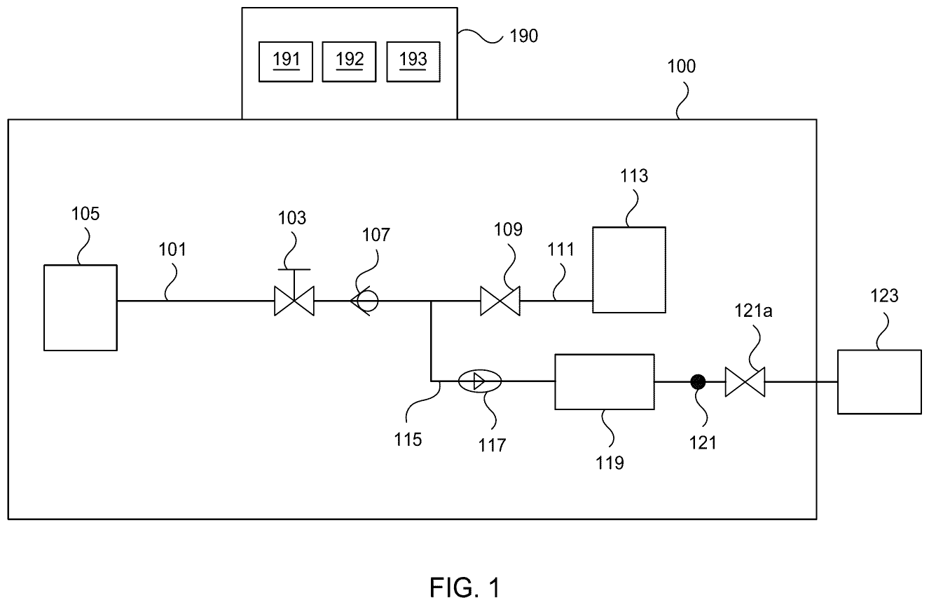

FIG. 1 is a schematic illustration of a fluid circuit 100 of a semiconductor processing system according to some embodiments. The circuit 100 includes a first conduit 101, a common conduit 115, a second conduit 111, and a controller 190. The common conduit 115 is coupled to a process chamber 123 configured for semiconductor manufacturing. For example, the first conduit 101 is a slurry supply line and the second conduit 111 is a deionized water line configured to supply the common conduit 115 to bring a fluid to the process chamber 123 when the process chamber 123 is a chemical mechanical polishing (CMP) chamber. In other embodiments, the first conduit 101 is a first processing gas supply line, the second conduit 111 is a second processing gas supply line, and the process chamber 123 may be a physical vapor deposition (PVD) chamber, an atomic layer deposition (ALD) chamber, a chemical vapor deposition chamber (CVD), an epitaxial deposition chamber, or another substrate processing chamber.

The common conduit 115 includes a pressure sensor 117 and a port 121a coupled to the process chamber 123. The pressure sensor 117 measures a pressure in the common conduit 115. The port 121a includes a port valve 121. In some embodiments, which may be combined with other embodiments, the common conduit 115 also includes a mass flow monitor 119. The mass flow monitor 119 is configured to measure a flow rate of fluid through the common conduit 115. In some embodiments which may be combined with other embodiments, the mass flow monitor 119 may also include a valve to stop flow through the common conduit 115

The first conduit 101 is coupled to the common conduit 115 by a first valve 103. The first conduit 101 receives a first fluid from a first fluid supply 105. The common conduit 115 receives the first fluid when the first valve 103 is opened.

The second conduit 111 is coupled to the common conduit 115 by a second valve 109. The second conduit 111 receives a second fluid from a second fluid supply 113.

The first valve 103 and the second valve 109 are disposed upstream of the port 121a. The port 121a is disposed downstream of the pressure sensor 117 and the mass flow monitor 119. The common conduit 115 is disposed downstream of the first valve 103 and the second valve 109.

The first valve 103, the second valve 109, and port valve 121 may be electronically controlled valves, normally open valves, normally closed valves, pneumatic valves, or other types of fluid control valves.

In some embodiments which may be combined with other embodiments, the circuit 100 also includes a check valve 107. The check valve 107 is shown downstream of the first valve 103, before the first conduit 101 is coupled to the common conduit 115, but may be disposed downstream of the second valve 109. The check valve 107 is configured to prevent back flow of fluid from one or both of the common conduit 115 and the second conduit 111 into the first conduit 101.

As illustrated in FIG. 1, the circuit 100 also includes a system controller 190. In some embodiments, operations of the circuit 100, are directed by the system controller 190. The system controller 190 includes a programmable central processing unit (CPU) 191 which is operable with a memory 192 (e.g., non-volatile memory) and support circuits 193. The support circuits 193 are conventionally coupled to the CPU 191 and comprise cache, clock circuits, input/output subsystems, power supplies, and the like, and combinations thereof coupled to the various components of the circuit 100, to facilitate control thereof. The CPU 191 is one of any form of general purpose computer processor used in an industrial setting, such as a programmable logic controller (PLC), for controlling various components and sub-processors of the processing system. The memory 192, coupled to the CPU 191, is non-transitory and is typically one or more of readily available memories such as random access memory (RAM), read only memory (ROM), floppy disk drive, hard disk, or any other form of digital storage, local or remote.

Typically, the memory 192 is in the form of a non-transitory computer-readable storage media containing instructions (e.g., non-volatile memory), which when executed by the CPU 191, facilitates the operation of the circuit 100. The instructions in the memory 192 are in the form of a program product such as a program that implements the methods of the present disclosure. The program code may conform to any one of a number of different programming languages. In one example, the disclosure may be implemented as a program product stored on computer-readable storage media for use with a computer system. The program(s) of the program product define functions of the embodiments (including the methods described herein). For example, the processor 191 causes a plurality of operations to be conducted.

Illustrative non-transitory computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory devices, e.g., solid state drives (SSD)) on which information may be permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are embodiments of the present disclosure. In some embodiments, the methods set forth herein, or portions thereof, are performed by one or more application specific integrated circuits (ASICs), field-programmable gate arrays (FPGAs), or other types of hardware implementations. In some other embodiments, the substrate processing and/or handling methods set forth herein are performed by a combination of software routines, ASIC(s), FPGAs and, or, other types of hardware implementations. One or more system controllers 190 may be used with one or any combination of the various modular polishing and/or cleaning systems described herein and/or with the individual polishing modules thereof.

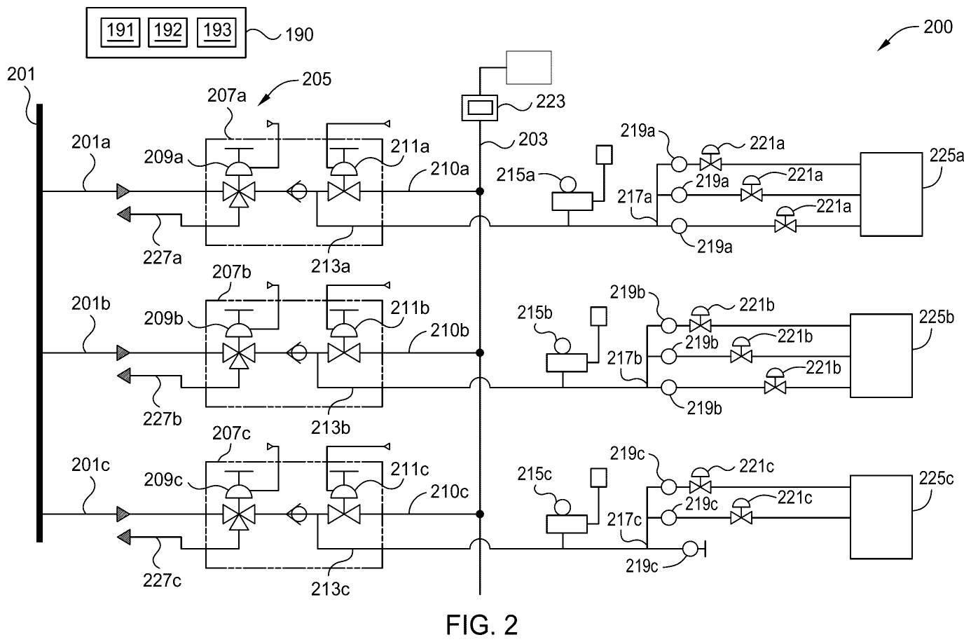

The controller 190 is configured to monitor fluid characteristics of the circuit 100 and the processing system 200 (FIG. 2). In some embodiments that may be combined with other embodiments, the controller 190 is configured to monitor the pressure of the common conduit 115 and the mass flow rate through the common conduit 115. The controller 190 receives signals from at least one or more of the first valve 103, the second valve 109, the pressure sensor 117, the mass flow monitor 119, and the port valve 121.

In some embodiments, which may be combined with other embodiments, the common conduit 115 supplies the first fluid from the first fluid supply 105 and the second fluid from the second fluid supply 113 to the process chamber 123 in an alternating fashion by following instructions from the controller 190. For example, the controller 190 instructs the first valve 103 to open while the second valve 109 is closed to supply the first fluid to the process chamber 123. In some embodiments, which may be combined with other embodiments, the mass flow monitor 119 may be used in a similar manner as the pressure sensor 117 or in conjunction with the pressure sensor 117. The method of signaling an error has occurred is described in more detail below.

FIG. 2 is a schematic illustration of a semiconductor processing system 200 according to some embodiments.

The semiconductor processing system 200 is similar to the fluid circuit 100 (FIG. 1). The semiconductor processing system 200 includes a first supply manifold 201 configured to supply a first fluid, a second supply manifold 203, the controller 190, and one or more supply circuits 205. The one or more supply circuits 205 are similar to the fluid circuit 100 of FIG. 1. The one or more supply circuits 205 include a first supply circuit 207a, a second supply circuit 207b, and a third supply circuit 207c. While three supply circuits 205 are shown more or fewer supply circuits are contemplated.

The first supply manifold 201 and the second supply manifold 203 are disposed upstream of the supply circuits 205. The semiconductor processing system 200 also includes a master flow meter 223. While shown on the second supply manifold 203, the master flow meter 223 may be disposed on the first supply manifold 201. In some embodiments, which may be combined with other embodiments, a first master flow meter 223 is disposed on the first supply manifold 201 and a second master flow meter 223 is disposed on the second supply manifold 203. The master flow meter 223 measures mass flow rate of a fluid being supplied to the one or more supply circuits 205.

The first supply circuit 207a includes a first conduit 201a, a common conduit 213a, and a second conduit 210a. The common conduit 213a is coupled to a process chamber 225a configured for semiconductor manufacturing. For example, the first conduit 201a is a slurry supply line and the second conduit 210a is a deionized water line configured to supply the common conduit 213a to bring a fluid to the process chamber 225a when the process chamber 225a is a chemical mechanical polishing chamber.

The common conduit 213a includes a pressure sensor 215a and one or more outlets 217a coupled to the process chamber 225a. The pressure sensor 215a measures a pressure in the common conduit 213a. The one or more outlets 217a each include a port valve 221a. In some embodiments, which may be combined with other embodiments, the one or more outlets 217a each also include a mass flow monitor 219a. The mass flow monitor 219a is configured to measure a flow rate of fluid through its corresponding outlet of the one or more outlets 217a.

The first conduit 201a is coupled to the common conduit 213a by a first valve 209a. The first conduit 201a receives the first fluid from the first manifold 201. The common conduit 213a receives the first fluid when the first valve 209a is opened.

In some embodiments, which may be combined with other embodiments, the first valve 209a is a three way valve configured to selectively supply the first fluid to the common conduit 213a when the first valve 209a is in a first state and supply the first fluid to a foreline 227a in a second state. When the first valve 209a is in a first state the first fluid does not travel to the foreline 227a and when the first valve 209a is in a second state, the first fluid does not travel to the common conduit 213a.

The second conduit 210a is coupled to the common conduit 213a by a second valve 211a. The second conduit 210a receives a second fluid from the second manifold 203. The common conduit 213a receives the second fluid when the second valve 211a is opened.

The first valve 209a and the second valve 211a are disposed upstream of the one or more outlets 217a. The one or more outlets 217a are disposed downstream of the pressure sensor 215a and the mass flow monitor 219a. The common conduit 213a is disposed downstream of the first valve 209a and the second valve 211a.

The second supply circuit 207b includes a first conduit 201b, a common conduit 213b, and a second conduit 210b. The common conduit 213b is coupled to a process chamber 225b configured for semiconductor manufacturing. For example, the first conduit 201b is a slurry supply line and the second conduit 210b is a deionized water line configured to supply the common conduit 213b to bring a fluid to the process chamber 225b when the process chamber 225b is a chemical mechanical polishing chamber.

The common conduit 213b includes a pressure sensor 215b and one or more outlets 217b coupled to the process chamber 225b. The pressure sensor 215b measures a pressure in the common conduit 213b. The one or more outlets 217b each include a port valve 221b. In some embodiments, which may be combined with other embodiments, the one or more outlets 217b each also include a mass flow monitor 219b. The mass flow monitor 219b is configured to measure a flow rate of fluid through its corresponding outlet of the one or more outlets 217b.

The first conduit 201b is coupled to the common conduit 213b by a first valve 209b. The first conduit 201b receives the first fluid from the first manifold 201. The common conduit 213b receives the first fluid when the first valve 209b is opened.

In some embodiments, which may be combined with other embodiments, the first valve 209b is a three way valve configured to selectively supply the first fluid to the common conduit 213b when the first valve 209b is in a first state and supply the first fluid to a foreline 227b in a second state. When the first valve 209b is in a first state the first fluid does not travel to the foreline 227b and when the first valve 209b is in a second state, the first fluid does not travel to the common conduit 213b.

The second conduit 210b is coupled to the common conduit 213b by a second valve 211b. The second conduit 210b receives a second fluid from the second manifold 203. The common conduit 213b receives the second fluid when the second valve 211b is opened.

The first valve 209b and the second valve 211b are disposed upstream of the one or more outlets 217b. The one or more outlets 217b are disposed downstream of the pressure sensor 215b and the mass flow monitor 219b. The common conduit 213b is disposed downstream of the first valve 209b and the second valve 211b.

The third supply circuit 207c includes a first conduit 201c, a common conduit 213c, and a second conduit 210c. The common conduit 213c is coupled to a process chamber 225c configured for semiconductor manufacturing. For example, the first conduit 201c is a slurry supply line and the second conduit 210c is a deionized water line configured to supply the common conduit 213c to bring a fluid to the process chamber 225c when the process chamber 225c is a chemical mechanical polishing chamber.

The common conduit 213c includes a pressure sensor 215c and one or more outlets 217c coupled to the process chamber 225c. The pressure sensor 215c measures a pressure in the common conduit 213c. The one or more outlets 217c each include a port valve 221c. In some embodiments, which may be combined with other embodiments, the one or more outlets 217c each also include a mass flow monitor 219c. The mass flow monitor 219c is configured to measure a flow rate of fluid through its corresponding outlet of the one or more outlets 217c.

The first conduit 201c is coupled to the common conduit 213c by a first valve 209c. The first conduit 201c receives the first fluid from the first manifold 201. The common conduit 213c receives the first fluid when the first valve 209c is opened.

In some embodiments, which may be combined with other embodiments, the first manifold 201 includes multiple fluids and supplies a different fluid to each of the one or more supply circuits 205. For example, the first supply circuit 207a receives a first fluid from the manifold 201, the second supply circuit 207b receives a second fluid distinct and different from the first fluid from the manifold 201, and the third supply circuit 207c receives a third fluid distinct and different from the first fluid and the second fluid, from the manifold 201.

In some embodiments, which may be combined with other embodiments, the first valve 209c is a three way valve configured to selectively supply the first fluid to the common conduit 213c when the first valve 209c is in a first state and supply the first fluid to a foreline 227c in a second state. When the first valve 209c is in a first state the first fluid does not travel to the foreline 227c and when the first valve 209c is in a second state, the first fluid does not travel to the common conduit 213c.

The second conduit 210c is coupled to the common conduit 213c by a second valve 211c. The second conduit 210c receives a second fluid from the second manifold 203. The common conduit 213c receives the second fluid when the second valve 211c is opened.

The first valve 209c and the second valve 211c are disposed upstream of the one or more outlets 217c. The one or more outlets 217c are disposed downstream of the pressure sensor 215c and the mass flow monitor 219c. The common conduit 213c is disposed downstream of the first valve 209c and the second valve 211c.

In some embodiments, which may be combined with other embodiments, the modules 225a 225b 225c are part of a corresponding chamber system having one or more chambers and each individual chamber of the one or more chambers is able to receive fluid from one or more supply circuits 205. For example, the modules 225a 225b 225c enable a first chamber of the chamber system to receive a first fluid from the first supply circuit 207a, a second fluid distinct and different from the first fluid from the second supply circuit 207b, and a third fluid distinct and different from the first fluid and the second fluid from the third supply circuit 207c.

The controller 190 is similar to the controller of FIG. 1. The controller 190 receives signals from at least one of the master flow meter 223, the pressure sensors 215a, 215b, 215c, the first valves 209a, 209b, 209c, the second valves 211a, 211b, 211c, the mass flow monitors 219a, 219b, 219c, and the port valves 221a, 221b, 221c.

The controller 190 is configured to measure pressure within the common conduits 213a, 213b, 213c of the supply circuits 205 by receiving signals from the pressure sensors 215a, 215b, 215c. In some embodiments, which may be combined with other embodiments, the controller 190 also receives signals from the mass flow monitors 219a, 219b, 219c. The controller 190 uses signals from at least one or more of the pressure sensors 215a, 215b, 215c, the mass flow monitors 219a, 219b, 219c, and the master flow meter 223 to determine if an error has occurred. Errors include leaks and valve failures in the semiconductor processing system 200, but other errors are contemplated.

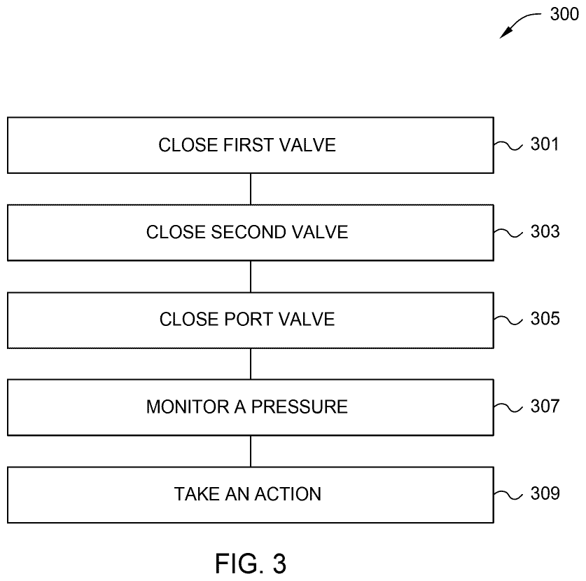

FIG. 3 is a schematic block diagram view of a method 300 of error signaling, according to one or more embodiments. The method 300 can be applied to the circuit 100 of a semiconductor processing system in FIG. 1 and the semiconductor processing system 200 of FIG. 2.

The method 300 detects failures in a fluid circuit of a processing system for use in semiconductor processing. At operation 301, the controller 190 closes a first valve to stop a first flow of a first fluid from a first conduit into a common conduit. The first valve may be either the first valve 103 or the second valve 109. The first valve 103 and the second valve 109 are not open at the same time to prevent contamination of the first fluid and the second fluid upstream of the first valve 103 and the second valve 109.

In some embodiments, which may be combined with other embodiments, the first valve 103 is open and supplying a polishing slurry to the process chamber 123 when the controller 190 sends signals to actuate the first valve 103, closing the first valve 103. The first fluid may be a fluid from the first fluid supply 105 that is supplied to the common conduit 115 when the first valve 103 is opened.

At operation 303, the controller 190 closes a second valve to stop a second flow of a second fluid from a second conduit into the common conduit. The second valve may be one of the first valve 103 or the second valve 109. In some embodiments, which may be combined with other embodiments, the second valve 109 is opened after the first valve 103 is closed and the second valve 109 allows the second fluid from the second fluid supply 113 to enter the common conduit 115. In some embodiments which may be combined with other embodiments, the second fluid rinses the common conduit 115 and/or and internal surface within the process chamber 123. For example, the second valve 109 supplies DI water to the process chamber 123 and then the controller 190 sends a signal to close the second valve 109.

In some embodiments, which may be combined with other embodiments, operations 301 and 303 cycle back and forth such that the first valve 103 and the second valve 109 alternate being open and closed and include a delay period between the closure of one valve and the opening of the other valve. For example, the first flow is separated from the second flow by 2 seconds or more to ensure the first fluid and second fluid cannot back flow upstream of the respective first valve 103 and second valve 109. In some embodiments, which may be combined with other embodiments, the back flow prevention is enhanced by having the first valve 103 and second valve 109 open separately so that the first flow and second flow occur at different times and do not overlap. During operations 301 and 303, the port valve 121 of the port 121a is open.

At operation 305, the controller 190 closes a port valve of the common conduit, downstream of the first conduit and the second conduit after a first delay period subsequent to closing the first valve and the second valve. The controller 190 actuates the port valve 121 after the first delay period. The controller 190 actuates the port valve while the first valve and the second valve are closed. The first delay period is about 0.1 seconds to about 10 seconds. For example, the first delay period is less than 3 seconds. In some embodiments, which may be combined with other embodiments, after the first valve 103 has actuated and supplied slurry, the second valve 109 has actuated and rinsed the common conduit 115, both, the first valve 103 and the second valve 109 are in a closed state. After the first delay period, the controller 190 actuates the port valve 121 to close the port valve 121, creating a sealed body within the common conduit 115. The first delay period allows fluid to leave the common conduit 115 before the port valve 121 closes. The pressure in the common conduit 115 stabilizes for a second delay period after the port valve 121 closes. The second delay period is about 0.1 seconds to about 10 seconds. For example, the second delay period is less than 3 seconds.

At operation 307, the controller 190 monitors a pressure in the common conduit for a third period. The controller 190 monitors the pressure of the common conduit 115 after the second delay period subsequent to closing the port valve 121. The third period is the time after the second delay period until the controller 190 receives a call for more fluid from the respective one or more supply circuits 205.

The pressure in the common conduit 115 is monitored during at least the third period, after the first valve 103, the second valve 109, and the port valve 121 of the port 121a have been closed for the second delay period. During the third period, the pressure of the common conduit 115 is checked. The pressure of the common conduit 115 may be checked in intervals or continuously. For example, the controller 190 checks the pressure of the common conduit 115 in intervals of about 20 milliseconds to about 70 milliseconds, for example every 50 milliseconds during the third period. The use of the first delay period and second delay period reduces the wear on the valves 103, 109, 121 from effects that include water hammer.

The controller 190 monitors the pressure of the common conduit 115 of the circuit 100 by the pressure sensor 117. The controller 190 determines if the pressure of the common conduit 115 is at a steady state during the third period, after the second delay period. The second delay period reduces sensor errors by allowing the circuit 100 to stabilize before sending pressure signals to the controller 190.

At operation 309, the controller 190 takes one or more actions if the pressure in the common conduit is outside of a first pressure threshold. In some embodiments, which may be combined with other embodiments, the controller 190 taking one or more actions includes creating and error signal if the pressure of the common conduit 115 is not at steady state during the third period or determines if the pressure of the common conduit 115 is within the first pressure threshold.

A non-steady state pressure signal will indicate a leak has occurred. For example, a leak could come from the failure of one or both of the first valve 103 and the second valve 109 leaking respective fluids into the common conduit 115 from either of the first fluid supply 105 or second fluid supply 113. In another example, if a leak has occurred, but the common conduit 115 is at a steady state pressure for the beginning of the third period, changes in pressure of one of the first fluid supply 105 or second fluid supply 113 could further trigger the change in pressure read by the pressure sensor 117.

The first pressure threshold can be a specific pressure, a pressure range, or a pressure with a variation. For example, the first pressure threshold may be atmospheric pressure. In some embodiments that may be combined with other embodiments, the first pressure threshold includes a set pressure with a +/−2% variation. For example, if the set pressure is 760 Torr, the first pressure threshold is about 745 Torr to about 770 Torr.

During the third period, the first valve 103, the second valve 109, and the port valve 121 of the port 121a are in a closed state and form a sealed cavity within the common conduit 115. If the one, or both, of the first valve 103 and the second valve 109 fail, fluid enters the common conduit 115 causing the controller 190 to receive a signal from pressure sensor 117 and determine the change in pressure is occurring outside of a call for fluid from the circuit 100 by the process chamber 123. The controller 190 determines a leak has occurred and creates the error signal when the pressure is not a steady state pressure. A steady state pressure includes a pressure reading varying by 0.5 pounds per square inch for 0.5 seconds. For example, a steady state pressure includes a pressure reading with a +/−2% variation.

In some embodiments that may be combined with other embodiments, the pressure in the common conduit 115 is continuously monitored by the controller 190. The pressure is stored and cross referenced at subsequent circuit states to further determine if a leak has caused an elevated pressure that is still at steady state. If a leak has caused an elevated steady state pressure, the controller 190 creates the error signal.

In some embodiments that may be combined with other embodiments, the error signal can be created at any time a system is in operation. For example, when the circuit 100 is flowing a fluid and the pressure changes outside of a response to a component being actuated, the controller 190 can take one or more actions. The one or more actions include one or more of: generating an error signal; close one or multiple valves; stopping a supply of energy to pumps, heaters, compressors, radio frequency generators, and motion devices in response to an error signal; and stopping flow within the fluid circuit 100. The controller 190 may also stop motion of components, close chambers, flush a space with a rinse fluid, and send instructions to other components or systems to perform other contamination reducing operations in response to an error signal. If the controller 190 reads a steady state pressure and/or the controller 190 reads a pressure within the first threshold, during the third period, the controller 190 maintains a run state for the circuit 100 until a call for fluid requires one or more of the valves 103, 109, 121 to be opened.

The controller 190 may also monitor a flow of fluid through the common conduit 115 with the mass flow monitor 119. In some embodiments that may be combined with other embodiments, the mass flow monitor 119 may also operate as the port valve 121. The controller 190 measures a flow rate within the common conduit 115 with the mass flow monitor 119.

The controller 190 takes an action if the flow rate is outside of a flow rate threshold within the third period. The flow rate threshold is about 0 gram/second to about 1 gram/second. The action includes one or more of creating an error signal when the mass flow monitor 119 reads a flow through the common conduit 115 during the third period when the valves 103, 109, 121 are supposed to be closed. The action includes one or more of: generating an error signal; close one or multiple valves; stopping a supply of energy to pumps, heaters, compressors, radio frequency generators, and motion devices in response to an error signal; and stopping flow within the fluid circuit 100. The controller 190 may also stop motion of components, close chambers, flush a space with a rinse fluid, and send instructions to other components or systems to perform other contamination reducing operations in response to an error signal.

At the end of the first delay period, second delay period, or during the third period, if the mass flow monitor 119 sends a value outside of a threshold for a mass flow rate through the common conduit 115, the controller 190 generates an error signal corresponding to a leak or component failure. In some embodiments which may be combined with other embodiments, the error signal identifies a leak associated with a component failure. In addition, the controller 190 may also store the mass flow rate value that corresponds the state of circuit 100.

In some embodiments which may be combined with other embodiments, the flow rate can also be used to compare subsequent operations. For example, when the port valve 121 and the first valve 103 are open and the second valve 109 is closed, the controller 190 reads and stores a first value of mass flow rate through the common conduit 115. At subsequent operations when the port valve 121 and the first valve 103 are open and the second valve 109 is closed, the controller 190 reads and stores a second value of mass flow rate through the common conduit 115. The controller 190 compares the first value and the second value to determine if there is a difference in values and generates an error signal in response to the differing values. A difference in flow rate values allows the controller to determine if a malfunction, leak, or issue has caused the difference between the first value and the second value. If the flow rates through the common conduit 115 correspond to the open and closed configurations of the valves 103, 109, 121 the controller 190 maintains a run state for the circuit 100.

If the controller 190 reads a value for a mass flow rate within the flow rate threshold through the common conduit 115 during the third period, the controller 190 maintains a run state for the circuit 100 until a call for fluid requires one or more of the valves 103, 109, 121 to be opened.

In some embodiments, which may be combined with other embodiments, the pressure sensor 117 measures the pressure in the common conduit 115 during and after the first delay period. If the pressure in the common conduit 115 does not change during the first delay period, the controller 190 takes one or more actions as described above. If the pressure in the common conduit is within a second pressure threshold after the first delay period the controller 190 maintains a run state. The second pressure threshold may be the same as the first pressure threshold. In some embodiments, which may be combined with other embodiments, the second pressure threshold has a larger variation than the first pressure threshold, for example +/−4%.

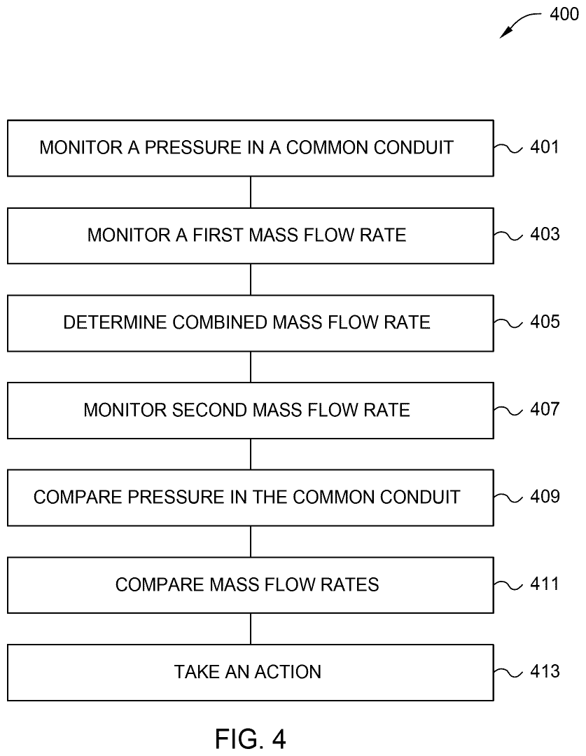

FIG. 4 is a schematic block diagram view of a method 400 of error signaling, according to one or more embodiments. The method 400 can be applied to the circuit 100 of a semiconductor circuit in FIG. 1 and the semiconductor processing system 200 of FIG. 2.

The method 400 is similar to the method 300. The method 400 includes the controller 190 communicating with the master flow meter 223 (FIG. 2) to determine if there has been a malfunction or leak.

At operation 401, the controller 190 monitors one or more fluid characteristics in one or more supply circuits 205 and fluid characteristics of at least one of the first supply manifold 201 and the second supply manifold 203. For example, the controller 190 monitors a pressure in the common conduit 213a, 213b, 213c of each of the one or more supply circuits 205 using the pressure sensor 215a, 215b, 215c of the respective common conduit 213a, 213b, 213c.

At operation 403, the controller 190 monitors a first mass flow rate through each outlet 217a, 217b, 217c of the one or more outlets of the one or more supply circuits 205 using the mass flow monitor 219a, 219b, 219c of the respective outlet 217a, 217b, 217c.

At operation 405, the controller 190 determines a combined mass flow rate through the one or more supply circuits 205 based on the monitored first mass flow rates through each outlet of the one or more outlets 217a, 217b, 217c of the one or more supply circuits 205. The combined mass flow rate is the mass flow rate for all fluid leaving the system 200 through the outlets 217a, 217b, 217c.

In some embodiments, which may be combined with other embodiments, the combined mass flow rate includes both the first fluid and the second fluid. In some embodiments, which may be combined with other embodiments, the combined mass flow rate is only the second fluid when the first valve 209a, 209b, 209c of each corresponding circuit 217a, 217b, 217c is closed. In some embodiments, which may be combined with other embodiments, the combined mass flow rate is only the first fluid when the second valve 209a, 209b, 209c of each corresponding circuit 217a, 217b, 217c is closed.

At operation 407, the controller 190 monitors a second mass flow rate through the master flow meter 223. The mass flow through the master flow meter 223 can be used to determine one or more of the flow of the first fluid and the second fluid though the one or more supply circuits 205.

In some embodiments, which may be combined with other embodiments, the master flow meter 223 is on the first supply manifold 201 and monitors the total flow rate of the first fluid through the one or more supply circuits 205. In some embodiments, which may be combined with other embodiments, the master flow meter 223 is on the second supply manifold 203 and monitors the total flow rate of the second fluid through the one or more supply circuits 205.

In some embodiments, which may be combined with other embodiments, a first master flow meter 223 is on the first supply manifold 201 and monitors the total flow rate of the first fluid through the one or more supply circuits 205 and a second master flow meter 223 is on the second supply manifold 203 and monitors the total flow rate of the second fluid through the one or more supply circuits 205.

At operation 409, the controller 190 compares a pressure in the common conduit 213a, 213b, 213c of each of the one or more supply circuits 205 with a pressure threshold. The pressure threshold can be a specific pressure, a pressure range, or a pressure with a variation. For example, the pressure threshold may be atmospheric pressure. In some embodiments that may be combined with other embodiments, the first pressure threshold includes a set pressure with a +/−2% variation. For example, if the set pressure is 760 Torr, the first pressure threshold is about 745 Torr to about 770 Torr.

At operation 411, the controller 190 compares the second mass flow rate with the combined mass flow rate. The second mass flow rate is determined by the master flow meter 223. The combined mass flow rate includes the flow of first fluid or second fluid flowing through the processing system 200 at that point in time. For example, the controller 190 compares the second mass flow at 10 liters per second with the combined mass flow rate at 11 liters per second and determines a delta of 1 liter per second is present. If the delta corresponds to a preset or pre-determined value then there is not an error and the controller 190 does not generate and error signal. Alternatively, if the second mass flow rate should be about equal to the combined mass flow rate, the delta is outside of the preset or pre-determined value indicating an error and the controller 190 does generates and error signal.

Operation 405, operation 407, operation 409, and operation 411 may happen simultaneously.

At operation 413, the controller 190 takes one or more actions in response to an error. An error includes if the pressure in the common conduit 213a, 213b, 213c in at least one of the one or more supply circuits 205 is outside of the pressure threshold during a period when the first valve 209a, 209b, 209c, the second valve 211a, 211b, 211c, and the port valve 221a, 221b, 221c corresponding to the respective common conduit are closed 213a, 213b, 213c.

For example, the controller 190 actuates one or more of the circuits 205. Actuating one or more of the circuits 205 includes controlling the valves 209a, 209b, 209c, 211a, 211b, 211c, 221a, 221b, 221c to place one or more of the circuits 205 in a state where the respective common conduit of the common conduits 213a, 213b, 213c forms a sealed cavity for pressure measurement. The controller 190 performs the method 300 on one or more of the circuits 205 during the operation of the semiconductor processing system 200.

In some embodiments which may be combined with other embodiments, the controller 190 communicates with the semiconductor processing system 200 to close first valve 209a, 209b, 209c or second valve 211a, 211b, 211c; close the opposite respective the first valves 209a, 209b, 209c or second valves 211a, 211b, 211c of each one or more supply circuits 205; after a first delay period close the respective port valves 221a, 221b, 221c; after a second delay period for each of the one or more supply circuits 205, monitor a pressure of the respective common conduits 213a, 213b, 213c for a third period of each circuit of the respective one or more supply circuits 205.

The controller 190 may perform the method 300 individually on the first supply circuit 207a, the second supply circuit 207b, and a third supply circuit 207c at individual times or simultaneously.

In some embodiments which may be combined with other embodiments, the controller 190 creates an error signal if the pressure in one or more of the common conduits 213a, 213b, 213c is not at a steady state pressure during the respective third period. The controller 190 may identify a leak in the one or more supply circuits 205 when the respective common conduits 213a, 213b, 213c should be in a steady state, but is not. A steady state pressure includes a pressure reading varying by 0.5 pounds per square inch for 0.5 seconds.

In addition to monitoring the pressure of the common conduits 213a, 213b, 213c during operation, the controller 190 also monitors mass flow rate of fluid through the one or more supply circuits 205 with the mass flow monitors 219a, 219b, 219c and the master flow meter 223. If the difference between the mass flow rate through the one or more supply circuits 205 and the second flow rate determined by the master flow meter 223 is outside of the preset or pre-determined values, the controller 190 generates the error signal.

In some embodiments which may be combined with other embodiments, during any third period, if the mass flow monitors 219a, 219b, 219c gives a non-zero value, the controller 190 may take an action including generating an error or error signal corresponding to a leak or component failure. A difference within preset or pre-determined values allows the controller 190 to determine if a malfunction, leak, or issue has occurred. Variation and thresholds allows for some variation due to measurement methods and measurement components.

For example, if the difference is within about 5%, the controller 190 maintains a run state for the semiconductor processing system 200. In another example, the controller 190 creates an error if the combined mass flow rate is outside of +/−4% of the mass flow rate through the master flow meter 223. An error also includes if the combined mass flow rate is outside of a flow threshold of the second mass flow rate for example, when the combined mass flow rate is outside of +/−5% of the second mass flow rate.

For example, the controller 190 compares the mass flow rate through the master flow meter 223 to the combined mass flow rate of fluid through the one or more supply circuits 205 to determine if there is a difference in preset or pre-determined values.

The error signal can be created at any time the semiconductor processing system 200 is in operation. For example, when the semiconductor processing system 200 is flowing a fluid and the pressure changes outside of a response to a component being actuated, the controller 190 can generate the error signal. The controller 190 may also close one or multiple valves, stop supplying energy to pumps, heaters, compressors, radio frequency generators, and motion devices in response to an error signal. The controller 190 may also stop motion of components, close chambers, flush a space with a rinse fluid, and send instructions to other components or systems to perform other contamination reducing operations in response to an error signal. If the controller 190 reads a steady state pressure during the first delay period, second delay period, and third delay period, the controller 190 maintains a run state for the semiconductor processing system 200.

The above described subject matter allows for enhanced maintenance and reduces the amount of time a leak or malfunction can go un-noticed. By actively monitoring at least the flows and pressures of the individual circuits and processing system, downtime and contaminated products can be reduced while through-put is enhanced.

What is claimed is:

1. A method of detecting failures in a fluid circuit of a processing system for use in semiconductor processing, comprising:
closing a first valve to stop a first flow of a first fluid from a first conduit into a common conduit;
closing a second valve to stop a second flow of a second fluid from a second conduit into the common conduit;
after a first delay period subsequent to closing the first valve and the second valve, closing a port valve of the common conduit, downstream of the first conduit and the second conduit;
after a second delay period subsequent to closing the port valve, monitoring, for a third period, a pressure in the common conduit; and
taking one or more actions if the pressure in the common conduit is outside of a first pressure threshold.

2. The method of claim 1, further comprising:
measuring, with a mass flow monitor, a flow rate within the common conduit; and
taking the one or more actions if the flow rate within the common conduit is outside of a flow rate threshold within the third period.

3. The method of claim 2, wherein the first pressure threshold has a +/−2% variation.

4. The method of claim 1, wherein the first fluid is a slurry and the second fluid includes water.

5. The method of claim 1, wherein the first delay period and the second delay period are about 2 seconds to about 5 seconds.

6. The method of claim 1, wherein the flow rate threshold is about 0 gram/second to about 1 gram/second.

7. The method of claim 1, wherein taking one or more actions includes one or more of creating an error signal and stopping a flow within a fluid circuit.

8. The method of claim 1, wherein, the first pressure threshold is about 745 Torr to about 770 Torr.

9. The method of claim 1, wherein the port valve is upstream of a processing chamber.

10. The method of claim 1, wherein the first flow and the second flow occur at different times.

11. The method of claim 1, further comprising:
measuring the pressure in the common conduit during and after the first delay period;
taking the one or more actions if the pressure in the common conduit does not change during the first delay period; and
maintaining a run state if the pressure in the common conduit is within a second pressure threshold after the first delay period.

12. A processing circuit for use in semiconductor processing, comprising:
a process chamber configured for semiconductor manufacturing;
a common conduit comprising:
a pressure sensor; and
a port coupled to the process chamber by a port valve;
a first conduit coupled to the common conduit by a first valve upstream of the port valve;
a second conduit coupled to the common conduit by a second valve upstream of the port valve; and
a controller comprising memory, the memory comprising instructions that, when executed by one or more processors, cause a plurality of operations to be conducted, the plurality of operations comprising:
closing the first valve to stop a first flow of a first fluid from the first conduit into the common conduit;
closing the second valve to stop a second flow of a second fluid from the second conduit into the common conduit;
after a first delay period subsequent to closing the second valve, closing the port valve of the common conduit;
after a second delay period subsequent to closing the port valve, monitoring, for a third period, a pressure in the common conduit using the pressure sensor; and
taking one or more actions if the pressure in the common conduit is outside of a first pressure threshold.

13. The processing circuit of claim 12, wherein the plurality of operations further comprise:
flowing the first fluid from the first conduit into the common conduit while the second valve is closed; and
flowing the second fluid from the second conduit into the common conduit while the first valve is closed.

14. The processing circuit of claim 12, wherein the pressure in the common conduit is continuously monitored.

15. The processing circuit of claim 12, further comprising a mass flow monitor disposed downstream of the first valve and the second valve, and disposed upstream of the port valve.

16. The processing circuit of claim 15, wherein the plurality of operations further comprise monitoring a flow rate through the common conduit with the mass flow monitor.

17. A processing system for use in semiconductor processing, comprising:
one or more supply circuits, each supply circuit of the one or more supply circuits comprising:
a common conduit comprising:
a pressure sensor; and
a port valve coupled to one or more outlets of the one or more supply circuits, each outlet of the one or more outlets comprising a mass flow monitor;
a first conduit coupled to the common conduit by a first valve upstream of the port valve;
a second conduit coupled to the common conduit by a second valve upstream of the port valve;
a first supply manifold coupled to the first conduit of each of the one or more supply circuits;
a second supply manifold coupled to the second conduit of each of the one or more supply circuits;
a master flow meter disposed upstream of the second supply manifold; and
a controller comprising memory, the memory comprising instructions that, when executed by one or more processors, cause a plurality of operations to be conducted, the plurality of operations comprising:
monitoring a pressure in the common conduit of each of the one or more supply circuits using the pressure sensor of the respective common conduit;
monitoring a first mass flow rate through each outlet of the one or more outlets of the one or more supply circuits using the mass flow monitor of the respective outlet;
determining a combined mass flow rate through the one or more supply circuits based on the first mass flow rate through each outlet of the one or more outlets of the one or more supply circuits;
monitoring a second mass flow rate through the master flow meter;
comparing a pressure in the common conduit of each of the one or more supply circuits with a pressure threshold;
comparing the second mass flow rate with the combined mass flow rate; and
taking one or more actions if:
the pressure in the common conduit in at least one of the one or more supply circuits is outside of the pressure threshold during a period when the first valve, the second valve, and the port valve corresponding to the respective common conduit are closed; or
the combined mass flow rate is outside of a flow threshold of the second mass flow rate.

18. The processing system of claim 17, wherein the one or more outlets are coupled to one or more chemical mechanical polishing (CMP) modules.

19. The processing system of claim 17, wherein the taking one or more actions comprises stopping flow through the one or more supply circuits when there is an error signal.

20. The processing system of claim 17, wherein the taking one or more actions comprises identifying a leak in the one or more supply circuits.
